(19) United States
(12) Patent Application Publication
(10) Pub. No.: US 2011/0090356 A1
(43) Pub. Date: Apr. 21, 2011

(54) IMAGING SYSTEM AND IMAGING PROCESSING METHOD THEREOF

(75) Inventor: Takashi Hirata, Yokohama-shi (JP)

(73) Assignee: CANON KABUSHIKI KAISHA, Tokyo (JP)

(21) Appl. No.: 12/899,134

(22) Filed: Oct. 6, 2010

(30) Foreign Application Priority Data
Oct. 20, 2009 (JP) 2009-241884

(51) Int. Cl. H04N 5/228

(52) U.S. Cl. 348/222.1; 348/E05.031

(57) ABSTRACT

An imaging system includes at least one imaging apparatuses, an imaging control apparatus configured to control an image photographing operation by the imaging apparatus, an imaging work control apparatus configured to control execution of processing in each apparatus, and an automatic image processing apparatus configured to correct an image photographed by the imaging apparatus based on an instruction from the imaging work control apparatus. The imaging work control apparatus manages an image processing flow which defines a series of processing contents to be executed for the image photographed by the imaging apparatus, and causes the automatic image processing apparatus to execute image processing in parallel to control of the image photographing operation by the imaging control apparatus based on the managed image processing flow.

### BACKGROUND OF THE INVENTION

1. Field of the Invention

The present invention relates to an imaging system and an imaging processing method thereof.

2. Description of the Related Art

There is known a photo studio where memorial photos and the like are taken. In the studio, a user (cameraman) takes photos using a digital camera, and the photographed images are displayed on the monitor of a personal computer. The user or the like thus confirms the photographed images on the spot.

Such an imaging system has a function of displaying a photographed image and simultaneously extracting the face of a person in the photographed image and displaying the extracted face image on the same screen as the photographed image. The user, for example, confirms the expression and focus by referring to the face image displayed on the same screen as the photographed image. Another system is known which determines focus or exposure of a photographed image, and warns the user of it. There is also known a system which executes image correction based on a manual instruction after image photographing so as to correct the image to quality recommended in each studio (for example, Japanese Patent Laid-Open No. 2006-178348).

If, for example, focus or exposure falls outside the prescribed range, the above-described imaging systems warn the user. However, correction processing itself needs to be done manually by the user.

In general, manual correction processing is executed after image photographing. In addition, the correction is performed after the customer has selected images to buy. For these reasons, the customer can view the corrected and finished images only after the bought images have been printed.

Even if image correction is performed reversely before the customer determines images to buy, they may need manual correction again after image photographing. Since enormous time is necessary, the customer must wait for a long time.

### SUMMARY OF THE INVENTION

The present invention provides an imaging system and imaging processing method, which allow apparatuses to execute a series of image photographing works parallelly in a distributed manner.

According to a first aspect of the present invention there is provided an imaging system comprising: at least one imaging apparatuses; an imaging control apparatus configured to control an image photographing operation by the imaging apparatus; an imaging work control apparatus configured to control execution of processing in each apparatus; and an automatic image processing apparatus configured to correct an image photographed by the imaging apparatus, based on an instruction from the imaging work control apparatus, the imaging work control apparatus comprising: a flow management unit configured to manage an image processing flow which defines a series of processing contents to be executed for the image photographed by the imaging apparatus; and an execution unit configured to cause the automatic image processing apparatus to execute image processing in parallel to control of the image photographing operation by the imaging control apparatus based on the image processing flow managed by the flow management unit.

According to a second aspect of the present invention there is provided an imaging method of an imaging system comprising: at least one imaging apparatuses; an imaging control apparatus configured to control an image photographing operation by the imaging apparatus; an imaging work control apparatus configured to control execution of processing in each apparatus; and an automatic image processing apparatus configured to correct an image photographed by the imaging apparatus based on an instruction from the imaging work control apparatus, the method of the imaging work control apparatus comprising: managing an image processing flow which defines a series of processing contents to be executed for the image photographed by the imaging apparatus; and causing the automatic image processing apparatus to execute image processing in parallel to control of the image photographing operation by the imaging control apparatus based on the managed image processing flow.

Further features of the present invention will be apparent from the following description of exemplary embodiments with reference to the attached drawings.

### BRIEF DESCRIPTION OF THE DRAWINGS

FIG. 1 is a block diagram showing an example of the overall arrangement of an imaging system according to an embodiment of the present invention;

FIG. 2 is a block diagram showing an example of the functional arrangement of a photographed image confirming apparatus 101 shown in FIG. 1;

FIG. 3 is a block diagram showing an example of the functional arrangement of an automatic image processing apparatus 104 shown in FIG. 1;

FIG. 4 is a block diagram showing an example of the functional arrangement of a manual image processing apparatus 105 shown in FIG. 1;

FIG. 5 is a block diagram showing an example of the functional arrangement of an imaging work control apparatus 102 shown in FIG. 1;

FIG. 6 is a view showing an example of a processing flow table;

FIG. 7 is a view showing an example of image status management;

FIG. 8 is a view showing an example of image photographing status management;

FIG. 9 is a view showing an example of customer status management;

FIG. 10 is a flowchart illustrating an example of the procedure of processing in the imaging system shown in FIG. 1;

FIG. 11 is a view showing an example of an image photographing preparation window;

FIG. 12 is a view showing an example of an image photographing window;

FIGS. 13A and 13B are flowcharts illustrating an example of the procedure of processing in the imaging system shown in FIG. 1;

FIG. 14 is a view showing an example of an image photographing status list window; and

FIG. 15 is a view showing an example of an image list window.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

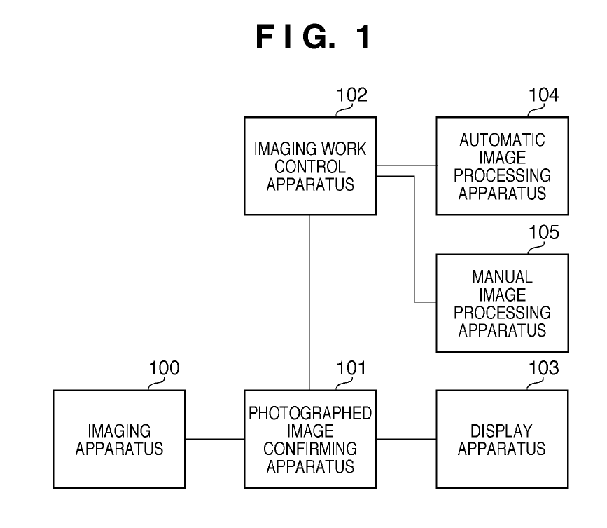

FIG. 1 is a block diagram showing an example of the overall arrangement of an imaging system according to an embodiment of the present invention.

The imaging system includes an imaging apparatus 100, photographed image confirming apparatus (imaging control apparatus) 101, imaging work control apparatus 102, display apparatus 103, automatic image processing apparatus 104, and manual image processing apparatus 105. The photographed image confirming apparatus 101 is communicably connected to the imaging apparatus 100 and the display apparatus 103. The imaging work control apparatus 102 is communicably connected to the automatic image processing apparatus 104 and the manual image processing apparatus 105. The photographed image confirming apparatus 101 and the imaging work control apparatus 102 are also communicably connected. Interfaces to be used to connect the apparatuses are not particularly limited. For example, a USB (Universal Serial Bus), LAN (Local Area Network), or the like is usable.

One or a plurality of imaging apparatuses 100 are provided to image an object (customer). The image photographing operation of the imaging apparatus 100 is performed based on an instruction from the photographed image confirming apparatus 101. Note that a photographed image is sent to the photographed image confirming apparatus 101.

The photographed image confirming apparatus 101 is used by a user for image photographing. More specifically, the user operates the photographed image confirming apparatus 101 to control the image photographing operation of the imaging apparatus 100. The user then refers to a monitor provided on the photographed image confirming apparatus 101 to confirm a photographed image. The photographed image confirming apparatus 101 is implemented by, for example, a PC (personal computer). Note that except a PC, for example, a terminal including a workstation, notebook PC, palmtop PC, various kinds of home electrical appliances such as a TV incorporating a computer, game machine, telephone, FAX, cellular phone, PHS, and electronic organizer or a combination thereof may implement the photographed image confirming apparatus 101.

The display apparatus 103 displays a photographed image or the like for the customer. The display apparatus 103 has, for example, a large-screen display. The display apparatus 103 displays not all photographed images but only those selected by the user on the photographed image confirming apparatus 101. For example, only well-made images are displayed for the customer.

The imaging work control apparatus 102 generally controls whole image photographing processing based on an image processing flow. The image processing flow defines a series of processing contents to be executed for an image obtained by the imaging apparatus 100. Note that the user sets the image processing flow in association with the imaging apparatus 100 before the start of image photographing. The imaging work control apparatus 102 also manages the progress status (information that combines image photographing, image, and customer statuses) of the entire image photographing work, and controls the apparatuses based on the image processing flow and the progress status of the entire image photographing work. This enables the apparatuses in the system to operate in parallel.

The automatic image processing apparatus 104 automatically corrects an image based on an instruction from the imaging work control apparatus 102. Note that the imaging work control apparatus 102 requests image correction of the automatic image processing apparatus 104 based on the image processing flow.

The manual image processing apparatus 105 manually corrects an image based on a user (for example, operator) instruction. That is, the operator uses the manual image processing apparatus 105 to manually correct an image.

An example of the overall arrangement of the imaging system has been described above. The system configuration shown in FIG. 1 is merely an example, and the present invention is not limited to this. For example, each apparatus in the system need not always be constructed as a physical apparatus, and for example, the imaging work control apparatus 102 and the photographed image confirming apparatus 101 may be implemented as one apparatus. In addition, for example, more than one automatic image processing apparatus 104 or manual image processing apparatus 105 may be provided. Providing a plurality of image processing apparatuses enables to shorten the time necessary for image correction in, for example, a large-scale photo studio where the image photographing count is enormous.

Each of the above-described imaging apparatus 100, photographed image confirming apparatus 101, imaging work control apparatus 102, display apparatus 103, automatic image processing apparatus 104, and manual image processing apparatus 105 incorporates a computer. The computer includes a main control unit such as a CPU and storage units such as a ROM (Read Only Memory), RAM, (Random Access Memory), and HDD (Hard Disk Drive). The computer also includes an input/output unit such as a keyboard, mouse, display, buttons, or touch panel. These components are connected via a bus or the like, and controlled by causing the main control unit to execute programs stored in the storage unit.

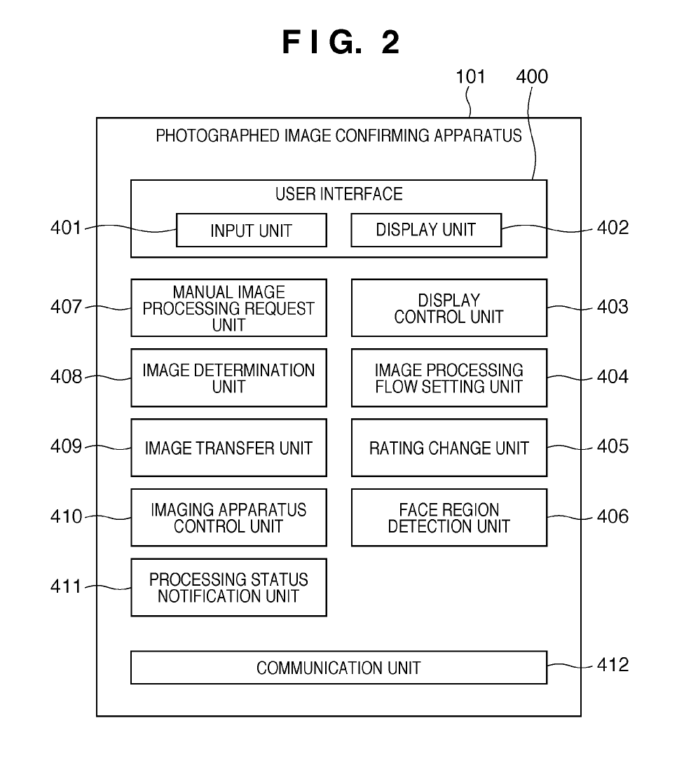

An example of the functional arrangement of each apparatus included in the imaging system shown in FIG. 1 will now be explained. An example of the functional arrangement of the photographed image confirming apparatus 101 will be described first with reference to FIG. 2.

The photographed image confirming apparatus 101 includes a user interface 400, display control unit 403, image processing flow setting unit 404, rating change unit 405, face region detection unit 406, and manual image processing request unit 407. The photographed image confirming apparatus 101 also includes an image determination unit 408, image transfer unit 409, imaging apparatus control unit 410, processing status notification unit 411, and communication unit 412.

The user interface 400 is an interface that connects the user and the photographed image confirming apparatus 101. The user interface 400 includes, for example, an input unit 401 such as a keyboard or mouse that inputs various kinds of instructions from the user, and a display unit 402 that displays various kinds of information for the user.

The display control unit 403 controls display of a photographed image, face region image, thumbnail image, or the like on the display unit 402. The image processing flow setting unit 404 sets an image processing flow based on a user instruction via the input unit 401. At the start of image photographing, the user sets the image processing flow in each imaging apparatus 100 to be used in image photographing.

The rating change unit 405 changes the rating of an image photographed by the imaging apparatus 100. That is, in this embodiment, the rate can be set for each photographed image. This makes it possible to exclude an image determined by the user to be poorly-made from the subsequent image processing flow.

The face region detection unit 406 detects a face region from the photographed image. The manual image processing request unit 407 transmits a manual image correction request to the imaging work control apparatus 102 based on a user instruction via the input unit 401. The communication unit 412 transmits/receives various kinds of data to/from the imaging apparatus 100, imaging work control apparatus 102, and display apparatus 103.

The image determination unit 408 determines an image to be transferred to the display apparatus 103. Note that this determination is done based on a user instruction. The image transfer unit 409 transfers a photographed image to the display apparatus 103 or imaging work control apparatus 102. Note that all photographed images are transferred to the imaging work control apparatus 102, whereas only images determined as transferable by the image determination unit 408 are transferred to the display apparatus 103.

The imaging apparatus control unit 410 controls the imaging apparatus 100. For example, the imaging apparatus control unit 410 transmits an image photographing instruction to the imaging apparatus 100 so as to remote-control its image photographing operation. The processing status notification unit 411 notifies the imaging work control apparatus 102 of the processing status (for example, image photographing and customer statuses). This allows the imaging work control apparatus 102 to obtain the processing status in the apparatuses and manage the progress status (image photographing, image, and customer statuses) of the entire image photographing work.

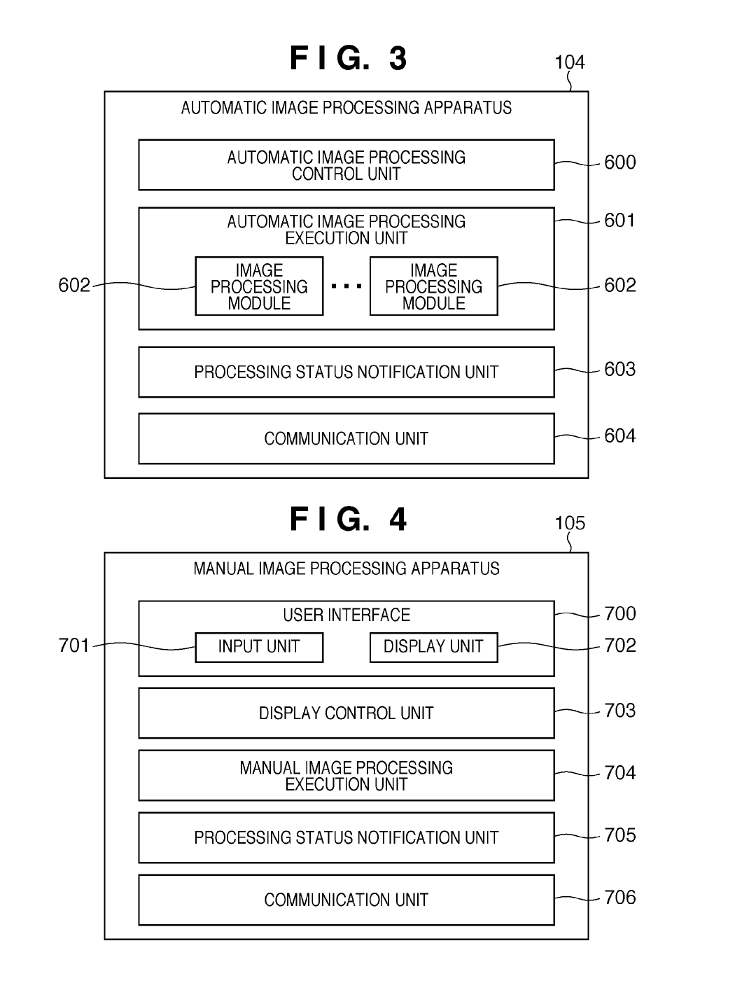

An example of the functional arrangement of the automatic image processing apparatus 104 will be described next with reference to FIG. 3.

The automatic image processing apparatus 104 includes an automatic image processing control unit 600, automatic image processing execution unit 601, processing status notification unit 603, and communication unit 604.

The automatic image processing control unit 600 controls image correction processing based on an image processing flow. Note that the image correction processing is performed based on an instruction from the imaging work control apparatus 102. The communication unit 604 transmits/receives various kinds of data to/from the imaging work control apparatus 102. The processing status notification unit 603 notifies the imaging work control apparatus 102 of the processing status (for example, image status). This allows the imaging work control apparatus 102 to obtain the processing status in the apparatuses and manage the progress status (image photographing, image, and customer statuses) of the entire image photographing work.

The automatic image processing execution unit 601 automatically executes image correction. The automatic image processing execution unit 601 includes a plurality of image processing modules 602 which performs various kinds of image processing (for example, trimming, exposure correction, and dust removal).

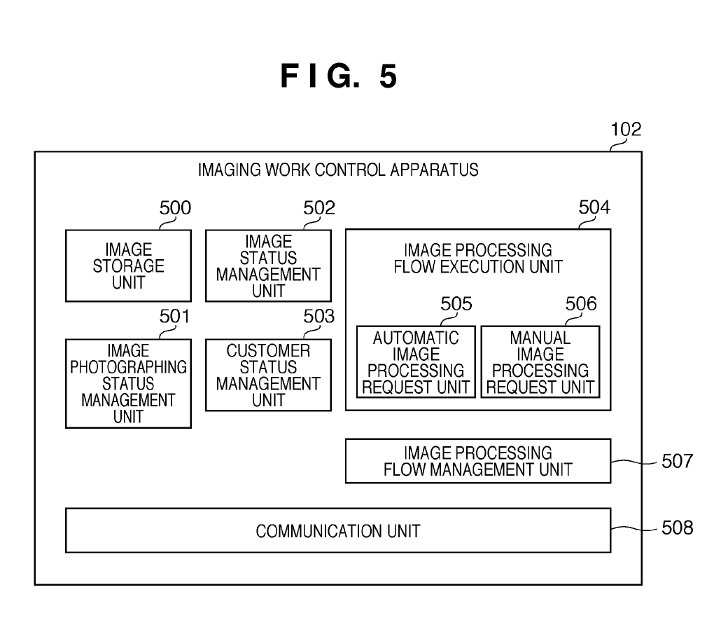

An example of the functional arrangement of the manual image processing apparatus 105 will be described next with reference to FIG. 4.

The manual image processing apparatus 105 includes a user interface 700, display control unit 703, manual image processing execution unit 704, processing status notification unit 705, and communication unit 706.

The user interface 700 is an interface that connects the user (for example, operator) and the manual image processing apparatus 105. The user interface 700 includes, for example, an input unit 701 such as a keyboard or mouse that inputs various kinds of instructions from the operator, and a display unit 702 that displays various kinds of information for the operator.

The display control unit 703 controls display of, for example, an image correction target image on the display unit 702. The manual image processing execution unit 704 executes image correction based on an operator instruction via the input unit 701. The communication unit 706 transmits/receives various kinds of data to/from the imaging work control apparatus 102. The processing status notification unit 705 notifies the imaging work control apparatus 102 of the processing status (for example, image status). This allows the imaging work control apparatus 102 to obtain the processing status in the apparatuses and manage the progress status (image photographing, image, and customer statuses) of the entire image photographing work.

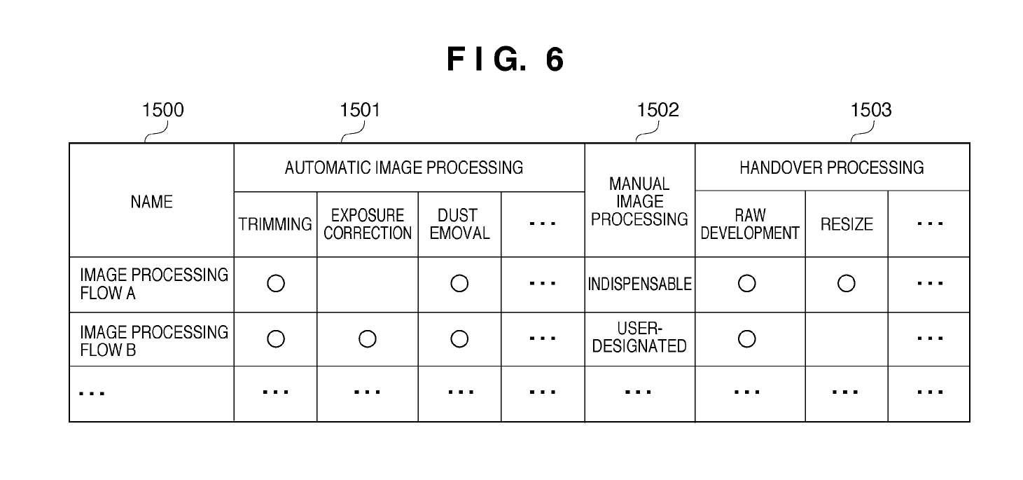

An example of the functional arrangement of the imaging work control apparatus 102 will be described next with reference to FIG. 5.

The imaging work control apparatus 102 includes an image storage unit 500, image photographing status management unit 501, image status management unit 502, customer status management unit 503, image processing flow execution unit 504, image processing flow management unit 507, and communication unit 508.

The image storage unit 500 stores photographed images and corrected images. The image photographing status management unit 501 manages the image photographing status. The image status management unit 502 manages the image (processing) status. The customer status management unit 503 manages the customer status. Note that the management processing of the image photographing status management unit 501, image status management unit 502, and customer status management unit 503 will be described later in detail.

The image processing flow management unit 507 manages an image processing flow. More specifically, the image processing flow management unit 507 receives and manages information concerning an image processing flow set by the photographed image confirming apparatus 101 (image processing flow setting unit 404). Note that image processing flows are managed using, for example, a table (processing flow table). The communication unit 508 transmits/receives various kinds of data to/from the photographed image confirming apparatus 101, automatic image processing apparatus 104, and manual image processing apparatus 105.

The image processing flow execution unit 504 controls the apparatuses based on an image processing flow managed by the image processing flow management unit 507 and the progress status of processing (information that combines image photographing, image, and customer statuses) in the apparatuses. This allows the apparatuses to execute a series of image photographing works parallelly in a distributed manner.

The image processing flow execution unit 504 includes an automatic image processing request unit 505 and a manual image processing request unit 506. The automatic image processing request unit 505 requests (automatic) image correction of the automatic image processing apparatus 104. The manual image processing request unit 506 requests (manual) image correction of the manual image processing apparatus 105.

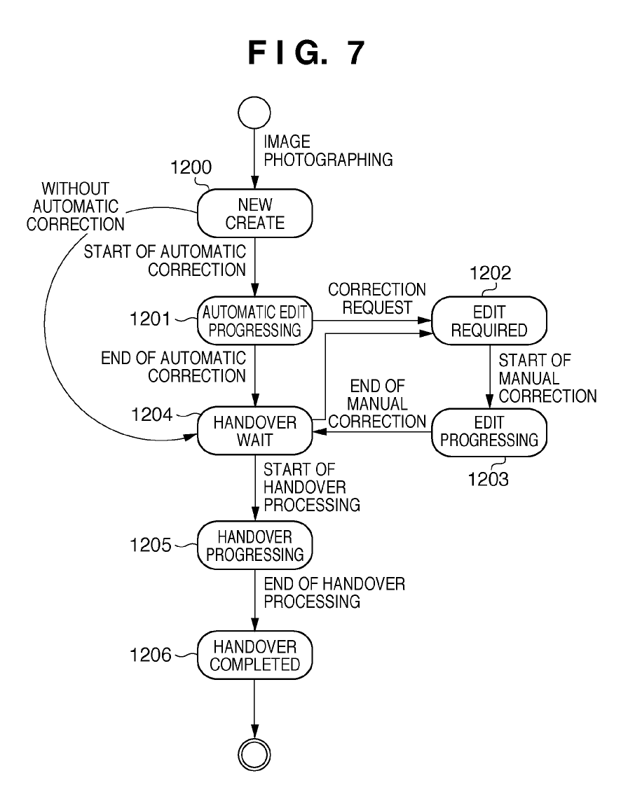

An example of the processing flow table managed by the image processing flow management unit 507 shown in FIG. 5 will be described here with reference to FIG. 6.

The processing flow table holds contents 1501 of automatic image processing, presence/absence 1502 of manual image processing, and contents 1503 of handover processing in correspondence with a name 1500 of each image processing flow. The contents 1501 of automatic image processing define which image processing items (in this case, trimming, exposure correction, dust removal, and the like) should be executed. As the presence/absence 1502 of manual image processing, “indispensable”, “user-designated”, or the like is set. If “indispensable” is set, the manual image processing apparatus 105 is always requested to do image correction. If “user-designated” is set, the manual image processing apparatus 105 is requested to do image correction when the photographed image confirming apparatus 101 issues an edit request.

The contents 1503 of handover processing define which processes (in this case, RAW development, resize, and the like) should be executed in accordance with the handover destination of an external system (for example, file system). An example of the processing flow table has been described above. Note that the table arrangement shown in FIG. 6 is merely an example, and can be changed as needed in accordance with the use environment of the imaging system or the like.

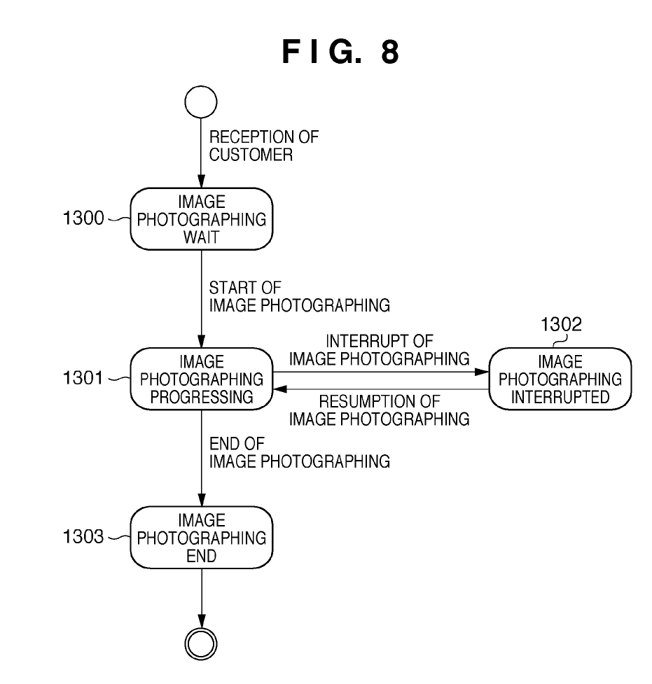

An example of image status management by the image status management unit 502 shown in FIG. 5 will be described next with reference to FIG. 7.

When an image photographed by the imaging apparatus 100 is sent to the photographed image confirming apparatus 101, the image status is a new create status 1200. When the automatic image processing apparatus 104 starts automatic correction, the image status transits from the new create status 1200 to an automatic edit progressing status 1201. Note that if the image processing flow defines that automatic image correction is unnecessary, the image status transits from the new create status 1200 to a handover wait status 1204.

Upon receiving a manual correction request in the automatic edit progressing status 1201, the image status transits from the automatic edit progressing status 1201 to an edit required status 1202. The user (for example, operator) manually executes image correction on the manual image processing apparatus 105. The image status then transmits from the edit required status 1202 to an edit progressing status 1203.

When automatic correction processing or manual correction processing has ended, the image status transits to the handover wait status 1204. Note that the handover wait status 1204 indicates that the image is in a status outputtable to an external system (for example, file system).

After that, when image photographing processing has ended, the image status transits from the handover wait status 1204 to a handover progressing status 1205. When handover processing has ended, the image status transits from the handover progressing status 1205 to a handover completed status 1206. The image status management thus ends.

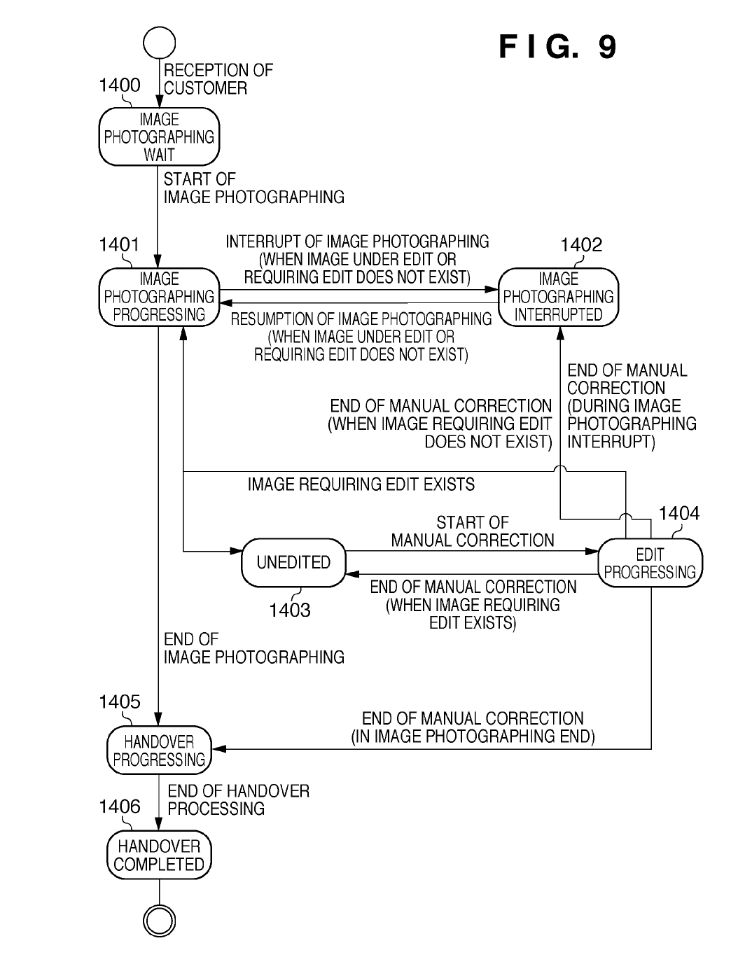

An example of image photographing status management by the image photographing status management unit 501 shown in FIG. 5 will be described next with reference to FIG. 8.

When a customer has made an application, the image photographing status is an image photographing wait status 1300. When image photographing starts, the image photographing status transits from the image photographing wait status 1300 to an image photographing progressing status 1301.

If image photographing is interrupted, the image photographing status transits from the image photographing progressing status 1301 to an image photographing interrupted status 1302. If image photographing has ended during the image photographing progressing status 1301, the image photographing status transits from the image photographing progressing status 1301 to an image photographing end status 1303. Image photographing status management thus ends.

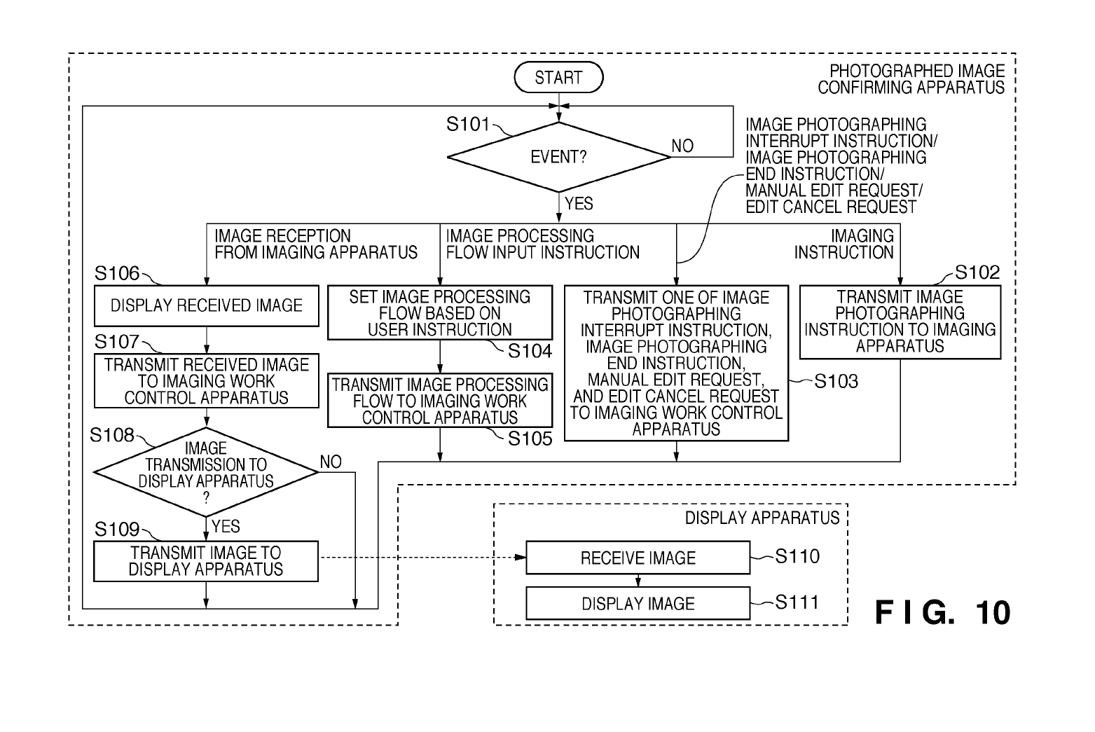

An example of customer status management by the customer status management unit 503 will be described next with reference to FIG. 9.

When a customer has made an application, the customer status is an image photographing wait status 1400. When image photographing starts, the customer status transits from the image photographing wait status 1400 to an image photographing progressing status 1401. If image photographing is interrupted, the customer status transits from the image photographing progressing status 1401 to an image photographing interrupted status 1402.

If no edit target image exists when the image status is the edit required status 1202 or edit progressing status 1203, the customer status transmits from the image photographing progressing status 1401 to the image photographing interrupted status 1402. Note that if image photographing is resumed in the image photographing interrupted status 1402, the customer status returns to the image photographing progressing status 1401.

If during the image photographing progressing status 1401, there is at least one image having (whose image status is) the edit required status 1202, the customer status transits from the image photographing progressing status 1401 to an unedited status 1403. When the manual image processing apparatus 105 starts manual correction during the unedited status 1403, the customer status transits from the unedited status 1403 to an edit progressing status 1404.

If during the image photographing progressing status 1401, the image photographing status transits to the image photographing end status 1303, and all images change to the handover wait status 1204, the customer status transits from the image photographing progressing status 1401 to a handover progressing status 1405. When handover processing of all images has ended in the handover progressing status 1405, the customer status transits from the handover progressing status 1405 to a handover completed status 1406.

When the image photographing status transits to the handover wait status 1204 during the edit progressing status 1404, the customer status transits from the edit progressing status 1404 to the handover progressing status 1405. If during the edit progressing status 1404, the image photographing status is the image photographing progressing status 1301, and no image whose image status is the edit required status 1202 exists, the customer status transits from the edit progressing status 1404 to the image photographing progressing status 1401. Note that if an image in the edit required status 1202 exists, the customer status transits from the edit progressing status 1404 to the unedited status 1403.

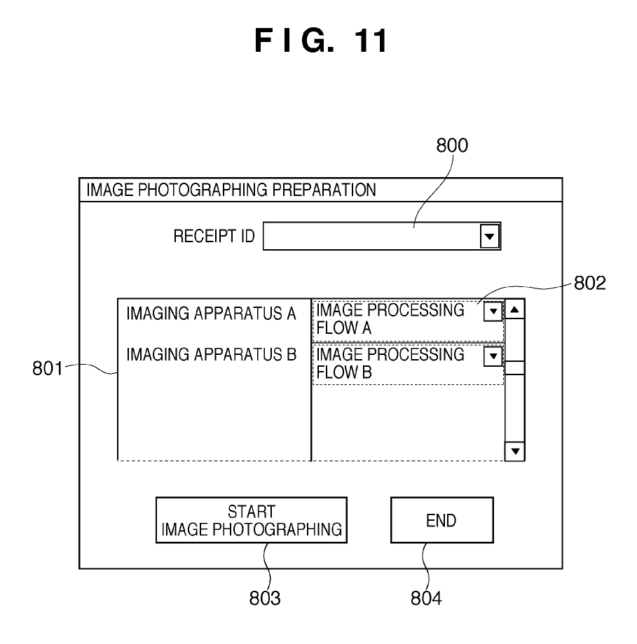

An example of the procedure of processing in the imaging system shown in FIG. 1 will be explained next. First, an example of the procedure of processing in the photographed image confirming apparatus 101 and the display apparatus 103 will be described with reference to FIG. 10.

The photographed image confirming apparatus 101 is waiting for an event (NO in step S101). Upon receiving an event from the user such as an operator or the imaging apparatus 100 (YES in step S101), the photographed image confirming apparatus 101 determines the event.

If the event is determined to be an image processing flow input instruction, the photographed image confirming apparatus 101 causes the image processing flow setting unit 404 to set an image processing flow based on the instruction (S104). The photographed image confirming apparatus 101 transmits the set image processing flow to the imaging work control apparatus 102 via the communication unit 412 (S105), and then returns to step S101 again to wait for an event.

If the event is determined in step S101 to be one of an image photographing interrupt instruction, image photographing end instruction, manual edit request, and edit cancel request, the photographed image confirming apparatus 101 transmits the instruction to the imaging work control apparatus 102 via the communication unit 412 (S103). Then, the photographed image confirming apparatus 101 returns to step S101 again to wait for an event.

If the event is determined in step S101 to be an image photographing instruction, the photographed image confirming apparatus 101 causes the imaging apparatus control unit 410 to instruct the imaging apparatus 100 to do image photographing (S102). Note that this instruction is transmitted to the imaging apparatus 100 via the communication unit 412.

If the event is determined in step S101 to be image reception from the imaging apparatus 100, the photographed image confirming apparatus 101 causes the display control unit 403 to display a window based on the received image on the display unit 402 (S106). In addition, the photographed image confirming apparatus 101 causes the image transfer unit 409 to transfer the received image to the imaging work control apparatus 102 (S107).

The photographed image confirming apparatus 101 causes the image determination unit 408 to determine whether to transfer the image to the side of the display apparatus 103. As described above, this determination is done based on a user instruction. For example, the user permits transfer of a well-made image. However, a poorly-made image need not be presented to the customer, and the user prohibits transfer of such an image.

If transfer is prohibited (NO in step S108), the photographed image confirming apparatus 101 returns to step S101 again to wait for an event. If transfer is permitted (YES in step S108), the photographed image confirming apparatus 101 causes the image transfer unit 409 to transfer the image to the display apparatus 103 (S109), and then returns to step S101 again to wait for an event. In this case, the photographed image confirming apparatus 101 can hand over the subsequent processing to the display apparatus 103. Hence, display on the display apparatus 103 and other processes are performed in parallel.

The display apparatus 103 receives the image (S110), and displays the received image (S111). Note that since only images determined by the user as well-done are sent to the display apparatus 103, as described above, persons such as the customer other than the user need not view ill-done images. This allows the customer to refer to only the well-done images on a large screen or the like.

An example of the procedure of processing in the photographed image confirming apparatus 101 and the display apparatus 103 has been described above. Note that although a description of processing of causing the photographed image confirming apparatus 101 to notify the imaging work control apparatus 102 of the processing status has been omitted in FIG. 10, the photographed image confirming apparatus 101 causes the processing status notification unit 411 to send the processing status any time.

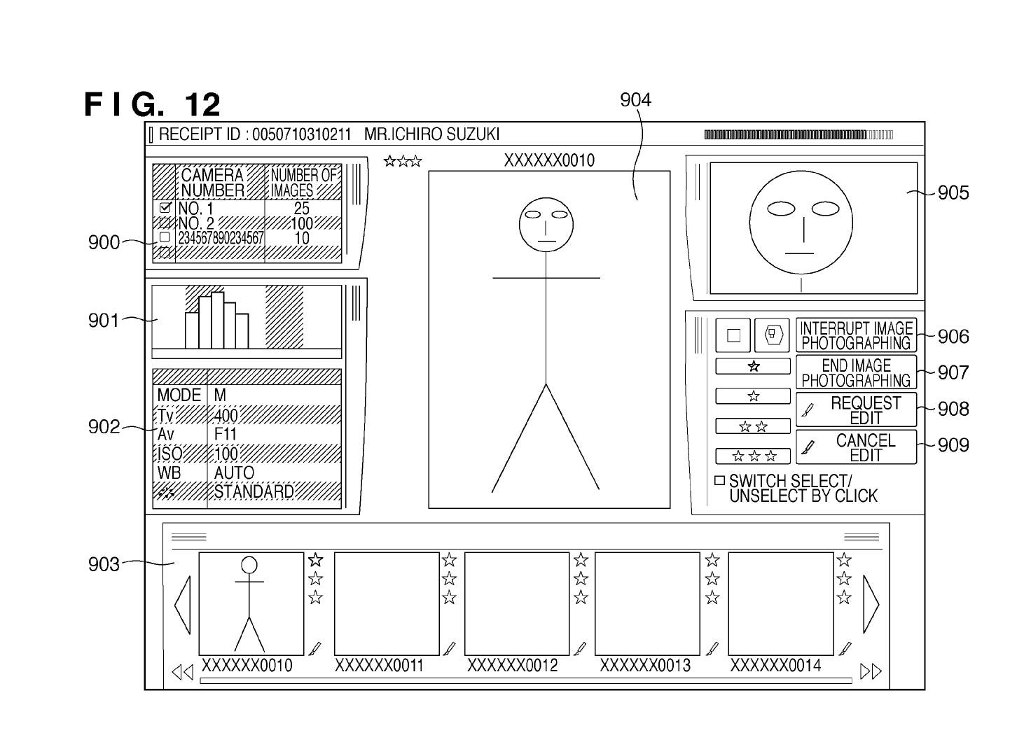

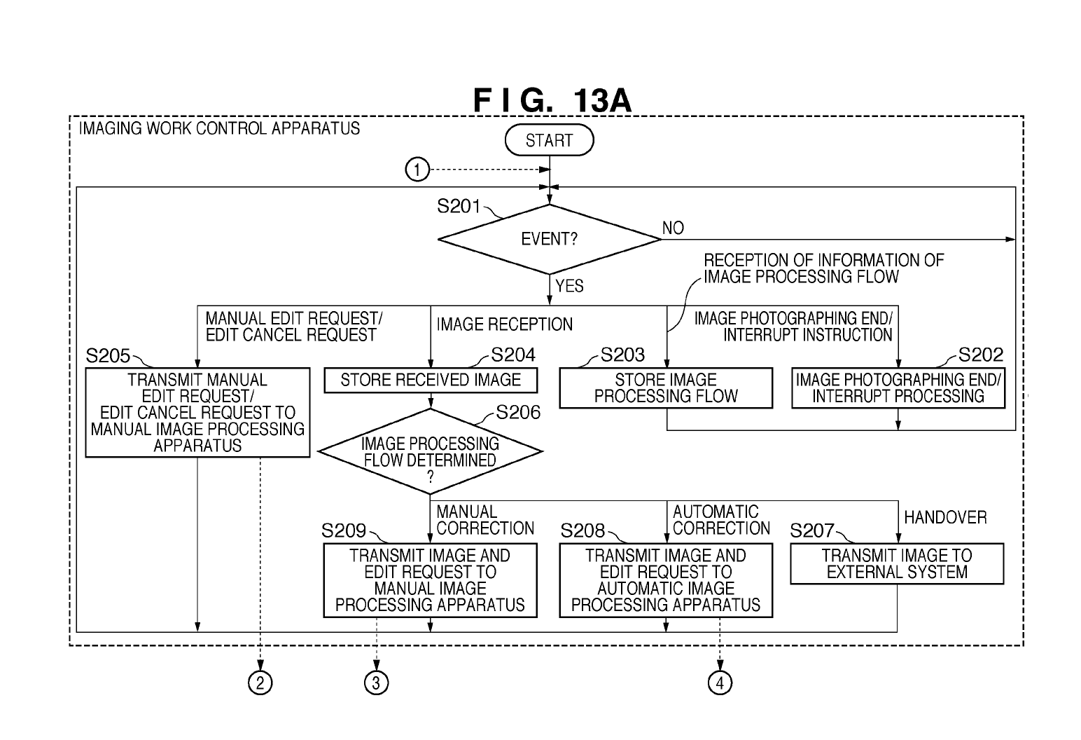

Examples of windows displayed on the display unit 402 of the photographed image confirming apparatus 101 will be described with reference to FIGS. 11 and 12. An image photographing preparation window to be used to input an image photographing instruction will be explained first. As shown in FIG. 11, the image photographing preparation window includes a receipt ID text box 800, use imaging apparatus list 801, image processing flow list 802, image photographing start button 803, and end button 804. The receipt ID text box 800 is a field to input the receipt ID of the customer. The use imaging apparatus list 801 is used to select the imaging apparatus 100 to be used for image photographing. The image processing flow list 802 is used to select an image processing flow. An image processing flow is selected from the drop-down list. When input to the above-described items and the like are completed, the user presses the image photographing start button 803. Image photographing thus starts.

An image photographing window to be used to display images photographed by the imaging apparatus 100 will be explained next. As shown in FIG. 12, the image photographing window includes an imaging apparatus list 900, histogram 901, image photographing parameter list 902, thumbnail image list 903, photographed image display region 904, and face image display region 905.

The imaging apparatus list 900 displays a list of imaging apparatuses 100. The thumbnail image list 903 displays a list of all images photographed by the imaging apparatus 100. The photographed image display region 904 displays an enlarged view of an image selected in the thumbnail image list 903. The histogram 901 displays, for example, the color components of the image displayed in the photographed image display region 904. The image photographing parameter list 902 displays a list of image photographing parameters upon photographing the image displayed in the photographed image display region 904. The face image display region 905 displays the face region of the image displayed in the photographed image display region 904. The user confirms, for example, the expression and focus by referring to the face image displayed in the face region. Note that the face region is detected by the face region detection unit 406 described with reference to FIG. 2. Each component of the image photographing window is provided to notify the user and the like of the information of the photographed image.

The image photographing window also includes an image photographing interrupt button 906, image photographing end button 907, edit request button 908, and edit cancel button 909. The user presses the image photographing interrupt button 906 to interrupt image photographing, and the image photographing end button 907 to end image photographing. The user presses the edit request button 908 upon determining that manual image correction is necessary. That is, pressing this button notifies the imaging work control apparatus 102 of a manual correction request. The edit cancel button 909 is used to cancel a correction request issued by the edit request button 908.

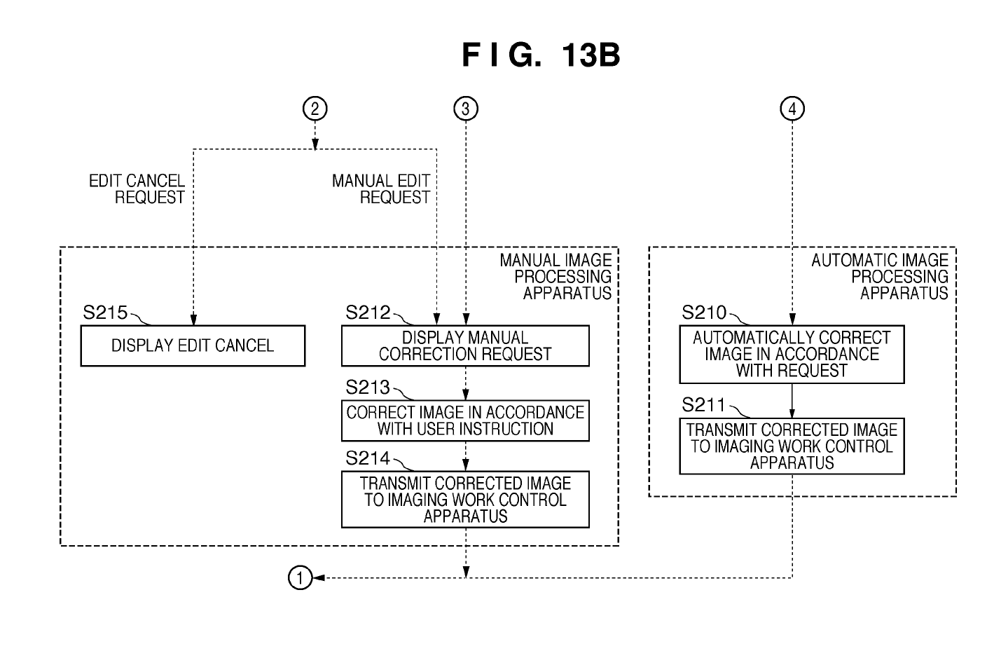

An example of the procedure of processing in the imaging work control apparatus 102, automatic image processing apparatus 104, and manual image processing apparatus 105 will be described next with reference to FIGS. 13A and 13B.

The imaging work control apparatus 102 is waiting for an event (NO in step S201). Upon receiving an event from another apparatus (YES in step S201), the imaging work control apparatus 102 determines the event.

If the event is determined to be an image photographing end/image photographing interrupt instruction, the imaging work control apparatus 102 executes image photographing end/interrupt processing (S202), and then returns to step S201 again to wait for an event. At this time, the imaging work control apparatus 102 causes the image photographing status management unit 501 to change the image photographing status to image photographing end/image photographing interrupt, as described with reference to FIG. 8.

If the event is determined in step S201 to be reception of image processing flow information, the imaging work control apparatus 102 causes the image processing flow management unit 507 to store the image processing flow in association with each imaging apparatus (S203). From then on, processing based on the stored image processing flow is performed for an image photographed by the imaging apparatus 100. The imaging work control apparatus 102 then returns to step S201 again to wait for an event.

If the event is determined in step S201 to be a manual edit request or edit cancel request, the imaging work control apparatus 102 causes, for a manual edit request, the manual image processing request unit 506 to transmit the edit request and an image to the manual image processing apparatus 105. For an edit cancel request, the imaging work control apparatus 102 transmits the edit cancel request to the manual image processing apparatus 105 (S205). The imaging work control apparatus 102 then returns to step S201 again to wait for an event. Upon receiving the edit cancel request, the manual image processing apparatus 105 causes the display control unit 703 to display, on the display unit 702, information representing that the edit request has been canceled (S215). Referring to the information, the user (for example, operator) recognizes that the image correction request has been canceled. Note that processing on the side of the manual image processing apparatus 105 that has received the manual edit request will be described later.

If the event is determined in step S201 to be reception of an image, the imaging work control apparatus 102 causes the image storage unit 500 to store the image (S204). At this time, the imaging work control apparatus 102 causes the image status management unit 502 to change the image status, as described with reference to FIG. 7, and the customer status management unit 503 to change the customer status, as described with reference to FIG. 9.

The imaging work control apparatus 102 causes the image processing flow execution unit 504 to start control based on the image processing flow managed by the image processing flow management unit 507 and the progress status (information that combines image photographing, image, and customer statuses) of the entire image photographing work.

To perform automatic correction, the imaging work control apparatus 102 causes the automatic image processing request unit 505 to transmit an edit request based on the image processing flow and a process target image to the automatic image processing apparatus 104 (S208). The imaging work control apparatus 102 then returns to step S201 again to wait for an event.

On the other hand, upon receiving the edit request and the image, the automatic image processing apparatus 104 causes the automatic image processing execution unit 601 to perform image correction (S210), and transmits the corrected image to the imaging work control apparatus 102 via the communication unit 604 (S211). Note that during image correction by the automatic image processing apparatus 104, the other apparatuses operate in parallel to the processing. For example, even when the photographed image confirming apparatus 101 or imaging apparatus 100 is performing image photographing processing, image correction for photographed images can be executed in parallel.

Upon determining in step S206 to perform manual correction, the imaging work control apparatus 102 causes the manual image processing request unit 506 to transmit an edit request and an image to the manual image processing apparatus 105 (S209). The imaging work control apparatus 102 then returns to step S201 again to wait for an event.

Upon receiving the edit request and the image, the manual image processing apparatus 105 causes the display control unit 703 to display, on the display unit 702, information representing the existence of the edit request (S212). Note that this display enables the operator to start manual image correction without waiting for the end of image photographing. Referring to the display, the operator recognizes that image correction is necessary, and inputs a correction instruction via the input unit 701. The manual image processing apparatus 105 causes the manual image processing execution unit 704 to perform image correction based on the user (operator) instruction (S213), and transmits the corrected image to the imaging work control apparatus 102 via the communication unit 706 (S214). Note that during image correction by the manual image processing apparatus 105, the other apparatuses operate in parallel, as in the case of the automatic image processing apparatus 104.

Upon determining in step S206 to perform handover processing, the imaging work control apparatus 102 outputs the corrected image to an external system (file system) via the communication unit 508 (S207).

An example of the procedure of processing in the imaging work control apparatus 102, automatic image processing apparatus 104, and manual image processing apparatus 105 has been described above. Note that a description of processing of causing the automatic image processing apparatus 104 and the manual image processing apparatus 105 to notify the imaging work control apparatus 102 of the processing status has partially been omitted in FIGS. 13A and 13B. In actual processing, however, the automatic image processing apparatus 104 and the manual image processing apparatus 105 cause the processing status notification unit 603 and the processing status notification unit 705 to send the processing status any time.

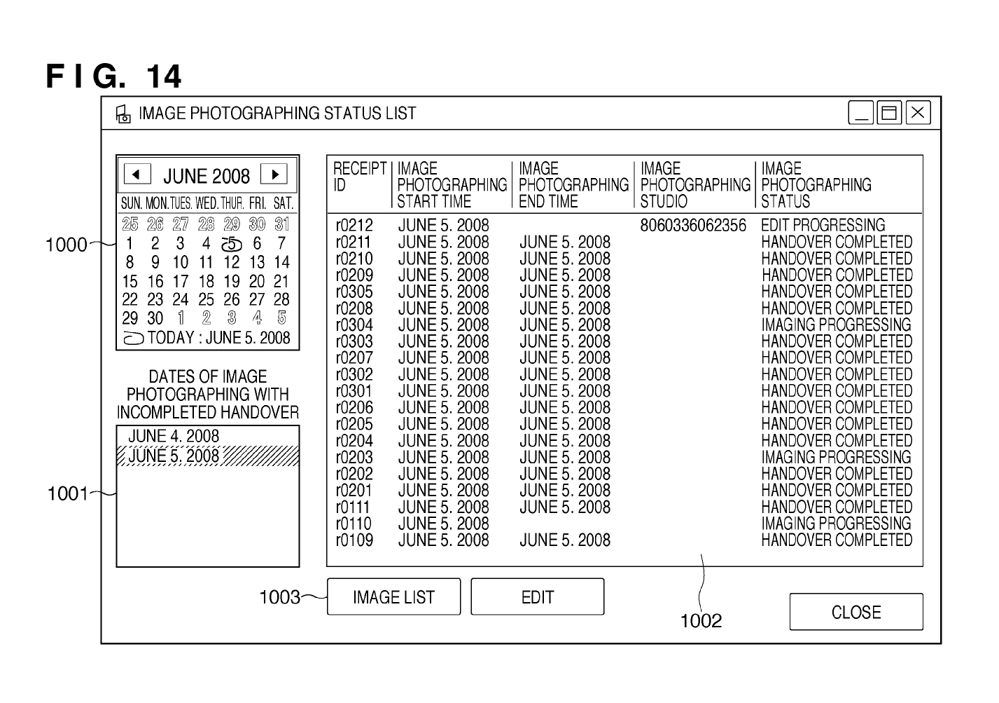

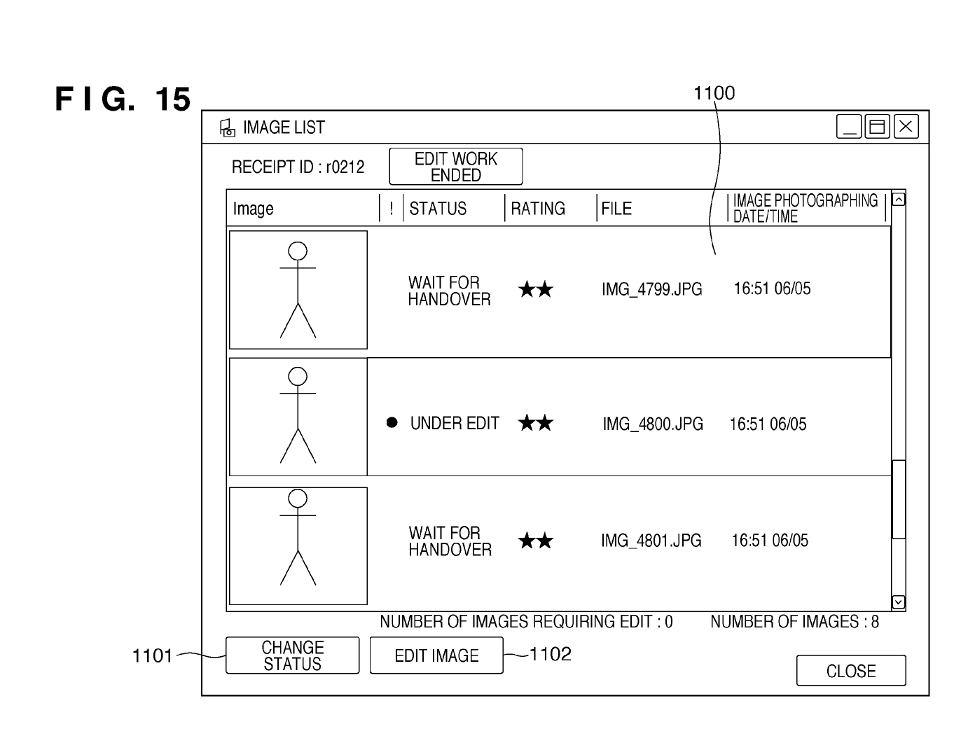

Examples of windows displayed on the display unit 702 of the manual image processing apparatus 105 will be described with reference to FIGS. 14 and 15. An image photographing status list window to be used to display customer information will be explained first. As shown in FIG. 14, the image photographing status list window includes a calendar region 1000, handover incompleted image list 1001, customer information list 1002, and image list button 1003.

When the user (for example, operator) designates a desired date in the calendar region 1000, a list of customer information corresponding to the date is displayed in the customer information list 1002. The displayed customer information includes, for example, the receipt ID, image photographing start time, image photographing end time, image photographing studio, and image photographing status. Note that the handover incompleted image list 1001 displays dates with images which have not ended processing yet. The operator selects customer information in the customer information list 1002, and double-clicks on it, or presses the image list button 1003. Then, a list of image information corresponding to the customer is displayed in the customer information list 1002.

An image list window to be used to manually correct an image will be explained next. As shown in FIG. 15, the image list window includes an image information list 1100, status change button 1101, and image edit button 1102.

The image information list 1100 displays a list of image information. When the user (for example, operator) selects an image, and presses the image edit button 1102, an image correction application starts up. This allows the operator to perform image correction. When the user presses the status change button 1101, the status of the image is changed. The imaging work control apparatus 102 is notified of this change.

As described above, according to this embodiment, an image processing flow is set in advance, and a series of image photographing works is performed by controlling each apparatus based on the set image processing flow. Since this allows the apparatuses to execute the series of image photographing works parallelly in a distributed manner, the time required for the image photographing works can shorten. For example, even during image photographing, image correction can be executed any time for a photographed image. This makes it possible to, for example, present well-finished images to a customer in a process before he/she finally selects images (photos) to buy.

If the user determines that only image correction automatically performed in accordance with the image processing flow is insufficient, image correction processing can be executed manually. This allows to obtain better-finished images.

A typical embodiment of the present invention has been described above. The present invention is not limited to the above-described and illustrated embodiment, and various changes and modifications can be made without departing from the spirit and scope of the invention.

Note that the present invention can take a form of, for example, a system, apparatus, method, program, or storage medium. More specifically, the present invention is applicable to a system including a plurality of devices, or an apparatus including a single device.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-241884 filed on Oct. 20, 2009, which is hereby incorporated by reference herein in its entirety.

What is claimed is:

1. An imaging system comprising:
at least one imaging apparatuses;
an imaging control apparatus configured to control an image photographing operation by said imaging apparatus;
an imaging work control apparatus configured to control execution of processing in each apparatus; and
an automatic image processing apparatus configured to correct an image photographed by said imaging apparatus, based on an instruction from said imaging work control apparatus,
said imaging work control apparatus comprising:
a flow management unit configured to manage an image processing flow which defines a series of processing contents to be executed for the image photographed by said imaging apparatus; and
an execution unit configured to cause said automatic image processing apparatus to execute image processing in parallel to control of the image photographing operation by said imaging control apparatus based on the image processing flow managed by said flow management unit.

2. The system according to claim 1, wherein
said imaging work control apparatus further comprises a management unit configured to obtain information representing a processing status from said imaging control apparatus and said automatic image processing apparatus, and manage the information, and
said execution unit causes said automatic image processing apparatus to execute image processing in parallel to control of the image photographing operation by said imaging control apparatus based on the image processing flow managed by said flow management unit and the information representing the processing status and managed by said management unit.

3. The system according to claim 1, wherein said flow management unit manages the image processing flow in association with each imaging apparatus.

4. The system according to claim 1, further comprising a manual image processing apparatus configured to correct the image based on an instruction of an operator,
wherein if the image processing flow defines manually correcting the image, said execution unit requests said manual image processing apparatus to execute manual correction in parallel to at least one of control of the image photographing operation by said imaging control apparatus and image processing by said automatic image processing apparatus.

5. The system according to claim 1, further comprising a manual image processing apparatus configured to correct the image based on an instruction of an operator,
wherein if a user instructs to manually correct the image, said execution unit requests said manual image processing apparatus to execute manual correction in parallel to at least one of control of the image photographing operation by said imaging control apparatus and image processing by said automatic image processing apparatus even if the correction is not defined by the image processing flow.

6. The system according to claim 4, wherein
said manual image processing apparatus comprises:
a display unit configured to, upon receiving a request of the manual correction from said imaging work control apparatus, display a message representing that the request of the manual correction has been received; and
a manual image processing execution unit configured to execute correction for an image based on the instruction of the operator.

7. The system according to claim 1, further comprising a display apparatus configured to display the image photographed by said imaging apparatus for a customer,
wherein said imaging control apparatus transmits, out of images photographed by said imaging apparatus, only images permitted by a user to said display apparatus, and
said display apparatus displays the images received from said imaging control apparatus for the customer.

8. An imaging method of an imaging system comprising:
at least one imaging apparatuses;
an imaging control apparatus configured to control an image photographing operation by the imaging apparatus;
an imaging work control apparatus configured to control execution of processing in each apparatus; and
an automatic image processing apparatus configured to correct an image photographed by the imaging apparatus based on an instruction from the imaging work control apparatus,
the method of the imaging work control apparatus comprising:
managing an image processing flow which defines a series of processing contents to be executed for the image photographed by the imaging apparatus; and
causing the automatic image processing apparatus to execute image processing in parallel to control of the image photographing operation by the imaging control apparatus based on the managed image processing flow.
